(19) United States
(12) Patent Application Publication
(10) Pub. No.: US 2016/0374421 A1
(43) Pub. Date: Dec. 29, 2016

(54) Hooded Sweatshirt with Integral Speakers

(71) Applicant: James Washington, Chicago, IL (US)

(72) Inventor: James Washington, Chicago, IL (US)

(21) Appl. No.: 15/047,535

(22) Filed: Feb. 18, 2016

Related U.S. Application Data
(60) Provisional application No. 62/117,806, filed on Feb. 18, 2015.

(51) Int. Cl. A42B 1/24; A41D 1/04; H04R 5/02; A42B 1/04; A41D 27/20; A45F 5/02; A41D 1/00; A42B 1/00

(52) U.S. Cl. CPC A42B 1/245; A41D 1/005; A41D 1/04; A42B 1/006; A42B 1/04; A42B 1/241; A41D 27/205; A41D 27/201; A45F 5/022; H04R 5/02; A41D 2200/20; A41D 2300/32; A45F 2200/0508; A45F 2200/0516; H04R 2201/023

(57) ABSTRACT

A hooded sweatshirt with integrated detachable audio speakers and wiring that function to provide stereo sound fidelity for connected portable devices, eliminating the inconvenience and discomfort of using earbuds or earphones.

### CLAIM OF PRIORITY

This patent application claims priority under 35 USC 119 (e) (1) from U.S. Provisional Patent Application Ser. No. 62/117,806 filed Feb. 18, 2015, of common inventorship herewith entitled, “Speakers in the Hoodie,” which is incorporated herein by reference as though the same were set forth in its entirety.

### FIELD OF THE INVENTION

The present invention pertains to the field of functional garments, and more specifically to the field of audio equipped garments.

### BACKGROUND OF THE INVENTION

The prior art has put forth several designs for audio equipped garments. Among these are:

U.S. Pat. No. 8,144,911 to Dar-Ming Chiang and Jen-Yuh Jiang describes a garment with a speaker function. The garment includes a garment body, a bag, and an electret speaker. The bag disposed on the garment body includes a sound absorbing layer. The electret speaker disposed in the bag gives off sounds to a first direction and a second direction at the same time. The sound absorbing layer absorbs the sound of the second direction. This invention provides convenience to a user and also enhances the acoustic quality of the electret speaker.

U.S. Pat. No. 8,107,653 to James Wolfe describes an audio source device used with a garment such as a hooded garment by passing audio wires into a channel in the hood and having them exit the hood inside hollow lanyards with earbuds at the ends. A means is provided to fix the wires and lanyards to each other inside the hood. A means is provided to prevent lateral movement inside the hood.

US Patent 2010/0078457 to Scott Pitchford and Charles Whitney describes a hooded backpack and speaker combination device which has a plurality of pockets on its shoulder straps. These pockets house various electronic devices including a switch pocket and switch which allow communication with a selected electric device by means of speakers housed within a hood attached to the top of the backpack.

US Patent 2006/0182297 to Terry Cyr and Theodore Sorum describes a wearable sound system comprising a garment and a speaker assembly. The system further comprises an audio device. In one embodiment, the audio device and the speaker assembly are detachably mounted to the garment. In another embodiment, the speaker assembly is integral with the garment. The speaker assembly comprises a fabric member positioned between a front and rear member, such that the fabric member is secured to the garment. The audio device and the speaker assembly are substantially water resistant such that the garment is washable with the components without damaging the components. The garment is a hooded garment, a backpack, or any other garment.

None of these prior art references describe the present invention.

### SUMMARY OF THE INVENTION

It is an object of the present invention to provide a hooded sweatshirt with integrated detachable audio speakers and wiring that function to provide stereo sound fidelity for connected portable devices, eliminating the inconvenience and discomfort of using earbuds or earphones.

### BRIEF DESCRIPTION OF THE DRAWINGS

FIG. 1 is a prototypical illustrative diagonal front view of the present invention showing speaker holding pockets with protective cloth barriers and small openings for electrical cord that runs down to an audio device stored in a front pocket.

FIG. 2 is an illustrative diagonal front see through view of the present invention showing detachable speakers with electrical wiring that connects and runs vertically downward to an audio device stored in a front pocket.

FIG. 3 is an illustrative top down view showing the round speaker and attached flexible electrical wiring removed from the present invention and functional as standalone portable speakers.

FIG. 4 is a front view of a pocket useful for storing an audio device.

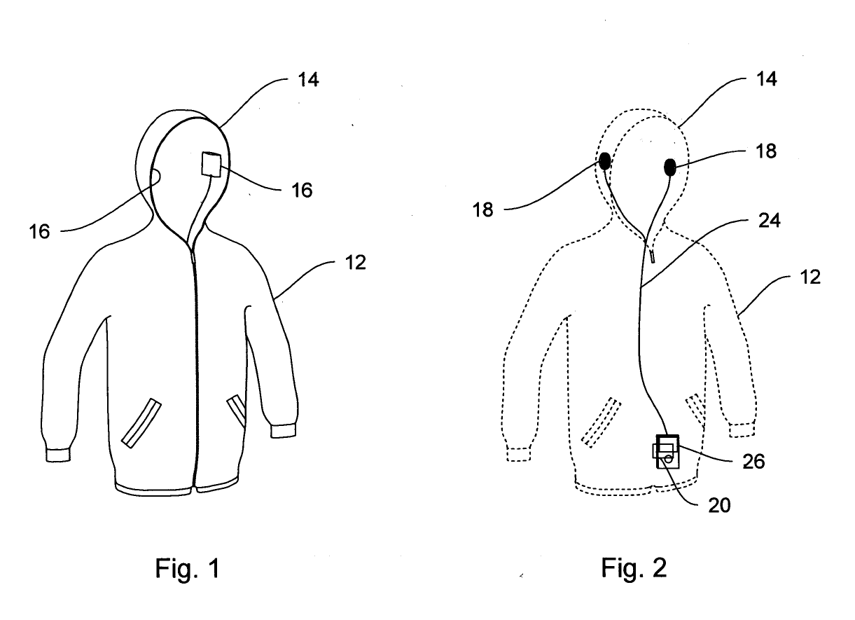

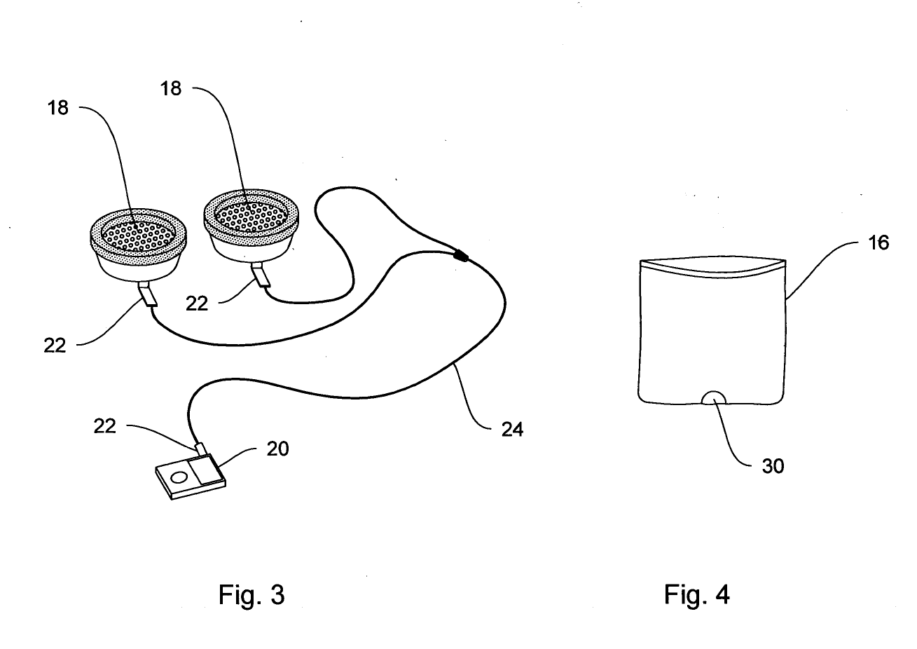

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Many people enjoy portable listening pleasure provided by current iPods, MP3 players, smart phones, tablet computers old school portable transistor radios, or other similar listening device. Earphones and earbuds are employed to enjoy audio on these devices. While earphones or earbuds provide listening pleasure, easy portability and privacy, they have a disturbing property of being ill fitting and consequently falling out of one's ear while moving. The attached earphone wires tend to get caught on things and pull the earphones out. This issue especially effects millions of individuals who enjoy wearing a hooded sweatshirt or hoodie. Additionally, earphone or earbuds prevent the user from hearing ambient sounds in the environment, which can lead to an unsafe situation, especially if the user is outside.

Please refer to the drawings. The present invention, hereinafter referred to as hooded sweatshirt with integral speakers, or Speakers in the Hoodie, is a hooded sweatshirt 12 with a hood 14 that incorporates a pair of pockets 16 for holding detachable stereo speakers 18 for use with a personal audio device 20 such as an iPod, MP3 player, smartphone, portable radio or other similar listening device. In an embodiment, pocket 16 can have a hole 30 in the bottom of the pocket to allow wires to run through the hole. Providing great sound fidelity without the inconvenience and discomfort of earbuds, the Speakers in the Hoodie is an ideal garment for cool weather outdoor work or recreation. The hood component 14 of this premium quality sweatshirt comprises a pair of compact, lightweight and detachable audio speakers 18 in a pair of hook and loop sealed pockets 16 on each interior side. The present invention is safer than a garment requiring earbuds or earphones. Not using earphones or earbuds also allows the user to hear ambient sounds in the environment.

The aforementioned speakers 18 are equipped with in line jacks 22. The attachable audio lines 24 are plastic coated speaker wires which are attached to the garment 12 by any suitable means, such as by running through a zippered sleeve or tube or attached by loops in the hood 14 down to a hook and loop sealed pouch or pocket 26 on the interior of the sweatshirt at the pocket or waist area where the wearer keeps their MP3 player or similar device 20. The speakers 18 are easily detachable by weans of the audio jacks 22 and hook and loop sealed pockets 16. The audio wires 24 running within and from the hood component 14 contain two jacks 22 at the top end for insertion into two speakers 18 and a single jack 22 at the bottom end for insertion into a portable device 20. Before laundering the wired hoodie, a user simply removes the speakers 18 from the integrated pockets 16 within the hoodie and then remove the jacks 22 and speaker wires 24 by unzipping the integrated tubes through which the wires run. With its audio components removed, the Speakers in the Hoodie cotton garment is machine washable and dryable.

The Speakers in the Hoodie is an ideal article of outerwear for a wide variety of active individuals from joggers and bicyclists to dock workers, truck drivers, painters, construction workers and even professional baseball and football players when they're in the dugout or on the bench. Speakers in the Hoodie garments are manufactured in a variety of sizes, colors and patterns to provide individuals of all ages and both sexes with a premium quality hooded sweatshirt that also contains high quality audio capability. When speaker components are removed from the sweatshirt garment, the round speaker and attached flexible electrical wiring can function as standalone portable speakers. With easy maintenance and constructed of high quality materials, Speakers in the Hoodie will withstand many years of highly functional and continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A hooded sweatshirt with integrated detachable audio speakers and wiring that function to provide stereo sound fidelity for connected portable devices, comprising:
a hooded sweatshirt with a hood that incorporates a pair of pockets inside the hood, wherein the pockets are capable of receiving detachable stereo speakers for use with a personal audio device.

2. The hooded sweatshirt of claim 1, wherein the speakers are a pair of compact, lightweight and detachable audio speakers.

3. The hooded sweatshirt of claim 1, wherein the pockets are located on interior side of the hood of sweatshirt at a position appropriate to cover or be near the ears of a wearer, and further wherein the pockets each have a hole in the bottom of the pocket.

4. The hooded sweatshirt of claim 3, wherein the pockets are sealed by hook and loop fasteners.

5. The hooded sweatshirt of claim 1, wherein the speakers are equipped with in line jacks to releasably connect to audio lines or wires to connect the speakers to an audio device.

6. The hooded sweatshirt of claim 5, wherein the audio lines or wires are plastic coated, and capable of running through a hole in the pocket in the hood through a zippered sleeve or tube or attached by loops in the hood down to an audio device.

7. The hooded sweatshirt of claim 5, wherein the audio device is located in a pouch or pocket on the interior of the sweatshirt, wherein the pocket is located at the pocket or waist area of the sweatshirt.

8. The hooded sweatshirt of claim 7, wherein the pocket or pouch in the sweatshirt capable of holding an audio device further comprises hook and loop fasteners.

9. The hooded sweatshirt of claim 1, wherein the speakers are easily detachable by means of two audio jacks at the top end of the wires for insertion into each speaker and further comprising a single jack at the bottom end for insertion into a portable device.

10. The hooded sweatshirt of claim 1, wherein the audio device is an iPod, MP3 player, smartphone, portable radio or other similar device.

11. The hooded sweatshirt of claim 3, wherein the audio device is an iPod, MP3 player, smartphone, portable radio or other similar device.

12. The hooded sweatshirt of claim 6, wherein the audio device is an iPod, MP3 player, smartphone, portable radio or other similar device.

13. The hooded sweatshirt of claim 7, wherein the audio device is an iPod, MP3 player, smartphone, portable radio or other similar device.

14. The hooded sweatshirt of claim 9, wherein the audio device is an iPod, MP3 player, smartphone, portable radio or other similar device.
